(19) United States
(12) Patent Application Publication
(10) Pub. No.: US 2017/0113146 A1
(43) Pub. Date: Apr. 27, 2017

(54) Ryan's play mobile sports application system and method

(71) Applicants: Joseph James Chung, Logan, UT (US); Lauren Autumn Deja, Logan, UT (US); Jacob David Elmore, Logan, UT (US); Elliott Joseph Likuang Liu, Logan, UT (US)

(72) Inventors: Joseph James Chung, Logan, UT (US); Lauren Autumn Deja, Logan, UT (US); Jacob David Elmore, Logan, UT (US); Elliott Joseph Likuang Liu, Logan, UT (US)

(21) Appl. No.: 15/330,628

(22) Filed: Oct. 21, 2016

Related U.S. Application Data
(60) Provisional application No. 62/285,327, filed on Oct. 26, 2015.

(51) Int. Cl. A63F 13/812; A63F 13/335; A63F 13/75; A63F 13/92

(52) U.S. Cl. CPC A63F 13/812; A63F 13/92; A63F 13/335; A63F 13/75

(57) ABSTRACT

Ryan's Play is a mobile sports application system and method for providing interactive play in a sports game in a game of skill to a plurality of participants each entering various guesses as to the outcome of a play or period of a real life sport game and accumulating winning points for successful guesses. Ryan's Play mobile sports application is a system and method that in real time allows a participant to point at a spot on a representation of a sports field as a guess and win points during sporting events or televised sporting events.

### CROSS-REFERENCE TO RELATED APPLICATIONS

Incorporated by reference is Provisional Patent Application U.S. 62/285,327, as noted in an Application Data Sheet of the present Non Provisional filing.

### STATEMENT REGARDING FEDERALLY SPONSORED RESEARCH DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Incorporated by reference is “Compact disk 1 for Android™” an original and a duplicate disk named rp-android containing a download of Ryan's Play Mobile Sports Application System and Method, containing the following files: File Folder .git, 642 MB, File Folder app, 16 MB, File .gitignore, 1 KB, File import-summary, 2 KB, and File settings.gradle, 1 KB.

Incorporated by reference is “Compact disk 2 for IOS™” an original and duplicate disk named rp-ios containing a download of Ryan's Play Mobile Sports Application System and Method, containing the following files: File Folder .git, 202 KB, File Folder Ryan's Play, 10.9 MB, File Ryan's Play 82,926 KB, File .gitignore 1 KB, and File README. ml 1 KB.
Incorporated by reference is “Compact disk 3” an original and duplicate disk named rp-api, containing backend server code with the following files; File Folders .git, 73.1 KB, ansible 2.24 KB, app, 1.71 KB, bin, 1.64 KB, config, 1.6 KB, db, 28.6 KB, doc, 106 KB, lib 11.8 KB, log min KB, public 348 KB, shared, 75.9 KB, spec, 52.3 KB, test, 312 bytes and vendor, min KB.

### STATEMENT REGARDING PRIOR DISCLOSURES BY THE INVENTOR OR A JOINT INVENTOR

The present invention is disclosed in Provisional Patent Application U.S. 62/285,327.

### BACKGROUND OF THE INVENTION

(1) Field of the Invention

The present invention relates to interactive sports applications and more particularly to mobile sports league game applications.

(2) Description of Related Art Including Information Disclosed Under 37 CFR 1.97 and 1.98

Instantaneous communications technology allows people to participate in games and more particularly in sports games simultaneously in the same location or across the nation. It allows for a form of entertainment that is interactive with live sporting events, and allows for competitive selection of the outcome of a sporting event.

There are no known mobile apps that allow a participant to play with others in real time that allow a participant to point at a spot on a representation of a sports field as a guess and win points during sporting events.

Accordingly, it would be advantageous to provide a mobile sports application to allow participants to select guesses in a real life sports event of the outcome of a particular play or period of a game.

It would still be further advantageous to provide a mobile sports application in real time that allows a participant to point at a spot on a representation of a sports field as a guess and win points during sporting events.

It would also be advantageous to provide a method for a mobile sports application to allow participants to select guesses in a real life sports event and accumulate winning points for an accurate guess of the outcome of a particular play or period of a game and rank participants according to number of points won.

It would further be advantageous to provide a mobile application system and method to provide guesses in real life sports events tailored to each of the major sports popular with a majority of the participants.

It is an object of the present invention to provide a mobile sports application system and method for interactive play among local and remote participants in the game of Baseball.

It is another object of the present invention to provide a mobile sports application system and method for interactive play among local and remote participants in the game of Football.

It is still another object of the present invention to provide a mobile sports application system and method for interactive play among local and remote participants in the game of Basketball.

It is a further object of the present invention to provide a mobile sports application system and method for interactive play among local and remote participants in the game of Cricket.

It is still a further object of the present invention to provide a mobile sports application system and method for interactive play among local and remote participants in the game of Soccer.

It is still a further object of the present invention to provide a mobile sports application system and method for interactive play among local and remote participants in the game of Ice Hockey.

It is yet a further object of the present invention to provide a mobile sports application system and method for interactive play among local and remote participants in the game of Golf.

It is still another object of the present invention to provide a mobile sports application system and method for interactive play among local and remote participants in the game of Tennis.

### BRIEF SUMMARY OF THE INVENTION

Ryan's Play is a mobile sports application system and method for providing interactive play in a sports game to a plurality of participants each entering various guesses as to the outcome of a play or period of a real life sport game and accumulating winning points for successful guesses. Ryan's Play mobile sports application is a system and method that in real time allows a participant to point at a spot on a representation of a sports field as a guess and win points during sporting events. A spot on a representation of a sports field can be a direction of a sports ball hit in a real time sporting event, or a location of a base or objective of the sport. A spot on a representation of a sports field can also be indicative of a home run, a strikeout, a pitcher hit, or a walk such as in the game of Baseball. Other sports will have possible guesses tailored to the sport's game rules. Ryan's Play mobile sports application system and method will accumulate winning points for a participant on successful guesses in a play or period of the game.

Selectable guess options are tailored to major sports such as: Baseball, Football, Basketball, Cricket, Ice Hockey, Soccer, Golf, and Tennis. However, other sports not mentioned are adaptable to the system and method of the present invention. Each participant has a smartphone or similar device with screens provided by the Ryan's Play mobile sports application system and method wherein a participant clicks selectable guess options prior to a play or period of a sports game, at a live on-screen game or at a sports event. The participants are rewarded based upon successful guesses of their prior selections. The interaction between participants and a real life on-screen sporting event or at an actual sports game provides entertainment and a form of competition in a game of skill.

The concepts and interaction of participants by means of mobile sports applications of the system and method of Ryan's Play is adaptable to other sports games and sporting events besides those included in this disclosure.

### BRIEF DESCRIPTION OF THE SEVERAL VIEWS OF THE DRAWINGS

FIG. 1 illustrates a flowchart of a process of utilizing the present invention. In Step 50, a group of players are generated related to a public game. The groups are user generated as they join a public game. At the start of the game or during a game in progress, a group is generated as participants log in via Facebook™ or by email. Participants to a public game are groups of friends or other people who join in for a game of skill.

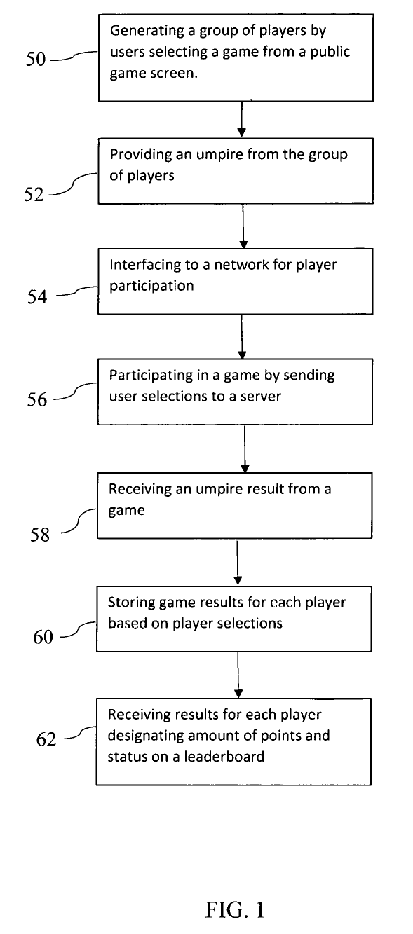

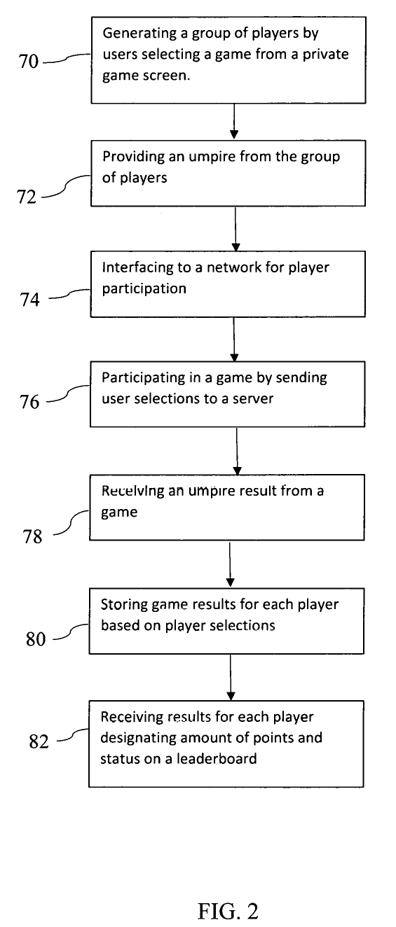

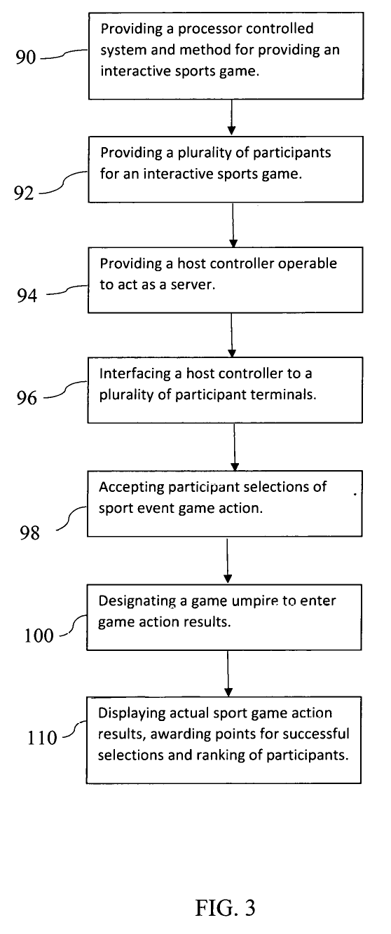

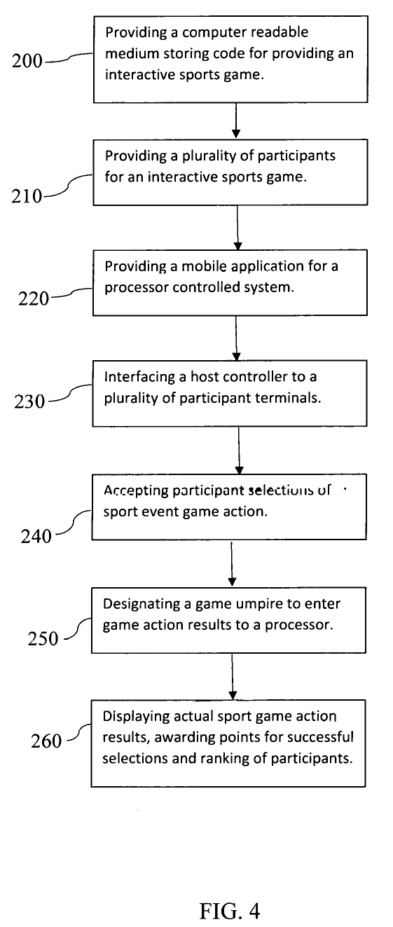

In Step 52, an umpire is selected from a group of participants, normally the participant who initiates a public play. Other participants can volunteer to be alternate umpires as the game progresses, when participants join in and select whether they will be alternate umpires.

In Step 54, participants interface to a network comprising a host controller with storage, an application stored in the host controller, and internet or dedicated communications medium to interface participant terminals to the host controller. Participant terminals are smartphones, personal digital assistants PDA's, tablets, or computers equipped with a mobile application of the present invention.

In Step 56, participants select an outcome of a game action by selecting pre-set alternative selections to a game action. In a game of baseball, these selections can be a batter's baseball hit field location, right field, left field, etc.

In Step 58, an umpire enters the successful sport game option selection in his umpire participant terminal which is interfaced to a network, communicating game option results to a host controller of Step 54.

In Step 60, a host controller of Step 54 stores a participant's successful selection and awards points to a participant, relaying this information to a participant's terminal. Further successful selections are continued to be awarded points and stored accumulating more points to a participant's game option total points. These game points will designate top participant total point for input to a leaderboard screen designating top participant rankings.

In Step 62, a participant receives accumulated points from Step 60, these accumulated points are further displayed on a participant's terminal and also displayed on a leaderboard screen with participant's ranking.

FIG. 2 illustrates a flowchart of a process of utilizing the present invention. In the Step 70, a group of players are generated related to a private game. The groups are user generated as they join a private game. At the start of the game, a group is generated as participants log in via Facebook™ or by email. Participants to a private game are groups of friends or other people who join in for a game of skill. Participants can only join this group at the start of the game, and not allowed to join while a game is in progress.

In Step 72, an umpire is selected from a group of participants, normally the participant who initiates a private game. Other participants can volunteer to be alternate umpires as they join the private game.

In Step 74, participants interface to a network comprising a host controller with storage, an application stored in the host controller, and internet or dedicated communications medium to interface participant terminals to the host controller. Participant terminals are smartphones, personal digital assistants, tablets, or computers equipped with a mobile application of the present invention.

In Step 76, participants select an outcome of a game action by selecting pre-set alternative selections to a game action. In a game of baseball, these selections can be a batter's baseball hit field location, right field, left field, etc.

In Step 78, an umpire enters the successful sport game option selection in his umpire participant terminal which is interfaced to a network, communicating game option results to a host controller of Step 74.

In Step 80, a host controller of Step 74 stores a participant's successful selection and awards points to a participant, relaying this information to a participant's terminal. Further successful selections are continued to be awarded points and stored accumulating more points to a participant's game option total points. These game points will designate top participant total point for input to a leaderboard screen designating top participant rankings.

In Step 82, a participant receives accumulated points from Step 70, these accumulated points are further displayed on a participant's terminal and also displayed on a leaderboard screen with participant's ranking.

FIG. 3 is a flowchart of a system and method for providing an interactive sports game. Step 90 displays a step of providing a computer-readable medium storing code for causing a processor controlled system for providing an interactive sports game to a plurality of participants. Step 92 displays the step of providing a plurality of participants with participant terminals such as hand held smartphones, tablets, personal digital assistants, or computer terminals equipped with a mobile application. Step 94 displays the step of providing a mobile application to a processor controlled system and participant terminals for providing an interactive sports game to a plurality of participants. Step 96 displays the step of interfacing the host controller to a plurality of participants using participant terminals such as smartphones or similar devices unto a network communicating with a host controller. Step 98 displays the step of accepting participant selections of a sport event action during a televised or actual sport event by the host controller. Step 100 displays the step of designating a participant as an umpire to enter actual results from a sport action in a sporting event in an umpire terminal communicating with the host controller. Step 110 displays the step of displaying on participant terminals the actual sport event results and awarding points to successful participant selections, saving these results in storage and displaying participant rankings in competition with other participants.

FIG. 4 is a flowchart of a mobile application system and method for providing an interactive sports game to a plurality of participants. Step 200 displays providing a computer readable medium storing code for causing a processor controlled system to provide an interactive sports game to a plurality of participants. Step 210 displays providing a plurality of participants with participant terminals such as hand held smartphones, tablets, personal digital assistants (PDA'S), or computer terminals equipped with a mobile application. Step 220 displays providing a mobile application to a processor controlled system and participant terminals for providing an interactive sports game to a plurality of participants. Step 230 displays interfacing a host controller to a plurality of participants using participant terminals such as smartphones or similar devices unto a network communicating with a host controller. Step 240 displays the step of accepting participant selections of a sport even game action during a televised or actual sport event, these participant game action selections accepted by a host controller. Step 250 displays designating a participant as an administrator, named an umpire, to enter actual results from a sport game action in a sporting event in an umpire terminal communicating with a host controller. Step 260 shows displaying on participant terminals the actual sport event results and awarding points to successful participant selections, saving these sport event results in storage and displaying participant rankings in competition with other participants.

### DETAILED DESCRIPTION OF THE INVENTION

Incorporated by reference is Provisional Patent Application U.S. 62/285,327, as noted in an Application Data Sheet of the present Non Provisional filing. Also incorporated by reference are the following:

Incorporated by reference is “Compact disk 1 for Android™” an original and a duplicate disk named rp-android containing a download of Ryan's Play Mobile Sports Application System and Method, containing the following files: File Folder .git, 642 MB, File Folder app, 16 MB, File .gitignore, 1 KB, File import-summary, 2 KB, and File settings.gradle, 1 KB.

Incorporated by reference is “Compact disk 2 for IOS™” an original and duplicate disk named rp-ios containing a download of Ryan's Play Mobile Sports Application System and Method, containing the following files: File Folder .git, 202 KB, File Folder Ryan's Play, 10.9 MB, File Ryan's Play 82,926 KB, File .gitignore 1 KB, and File README. ml 1 KB.
Incorporated by reference is “Compact disk 3” an original and duplicate disk named rp-api, containing backend server code with the following files; File Folders .git, 73.1 KB, ansible 2.24 KB, app, 1.71 KB, bin, 1.64 KB, config, 1.6 KB, db, 28.6 KB, doe, 106 KB, lib 11.8 KB, log min KB, public 348 KB, shared, 75.9 KB, spec, 52.3 KB, test, 312 bytes and vendor, min KB.

As disclosed in Provisional Patent Application U.S. 62/285,327, the present invention, Ryan's Play Mobile Application System and Method, is a mobile sports application system and method for providing interactive play in a sports game to a plurality of participants each entering various guesses as to the outcome of a play or period of a real life sport game and accumulating winning points for successful guesses.

Selectable guess options are tailored to major sports such as: Baseball, Football, Basketball, Cricket, Ice Hockey, Soccer, Golf, and Tennis. Each participant has a smartphone or similar device with screens provided by the Ryan's Play mobile sports application system and method wherein a participant clicks selectable guess options prior to a play or period of a sports game based on a live on-screen game or at a sports event. The participants are rewarded based upon successful guesses of their prior selections. The interaction between participants and a real life on-screen sports game or at an actual sports game provides entertainment and a form of competition in a game of skill.

The concepts and interaction of participants by means of mobile computer applications of Ryan's Play is adaptable to other sports games. We have included some major sport games in this disclosure, however the mobile sports application concepts of the present invention will adapt to other sports not mentioned in this disclosure.

In accordance to the above and one aspect of the present invention, there is provided a system and method for providing an interactive sports game to a plurality of participants each interactively selecting guesses as to an outcome of a play or period of a game, preferred field location of a ball, direction of play, and other particular guesses intrinsic to a particular sport. The system comprises a host controller, the host controller comprising a computer system and method operable to act as a record keeper on the network comprised of a plurality of participants, and to communicate with the participant's individually to record gains in points of the successful selections from the participants entered in a game screen of the present invention. The system is intended to entertain and is also a game of skill which rewards the most successful participants.

The participants are rewarded based upon their prior selection of selectable game options, entered into a smartphone screen of the present invention. The interaction between participants and a live on-screen sports game or at an actual game provides competition as a game of skill among the participants and entertainment.

Instantaneous communications technology allows people to participate in games and more particularly in sports games simultaneously in the same location or across the nation. Ryan's Play mobile sports application system and method allows for interactive selection of the outcome of a play or period of a sporting event.

As mentioned in the background of the present invention, this mobile application, Ryan's Play mobile sports application system and method allows a participant to play with others in real time and allows a participant to point at a spot on a representation of a sports field as a guess and win points during sporting events. As further disclosed, Ryan's Play mobile sports application system and method will allow a participant to guess at a spot on a representation of a sports field, locating a direction of play in real time and accumulate winning points for successful guesses. This disclosure will address the particulars of various sports and possible game guesses.

The present invention is a mobile sports application system and method for providing an interactive sports game to a plurality of participants wherein each participant selects on a smartphone or similar device a guess of game play options on a game screen of the terminal. The system is operable to:

(a) Accept an entry from each participant of the game an initial selection;

(b) Accept an entry from a participant designated an umpire; and

(c) Respond to an entry from the team's umpire, to access a data storage and report a status of the participant's acquired value points, the status including information as to the performance of the participants by ranking according to acquired game value points, the number of game value units associated with each participants successful selections.

Ryan's Play mobile sports application and method applicable to the game of Baseball is further discussed.

### Baseball

The present invention relates to a mobile sports application system and method and in this baseball disclosure more particularly to a baseball sports league game mobile application in which participants act as selectors of a baseball field location such as center field, right field, left field, short stop, etc., of a baseball's trajectory and location after a batter's hit on a real time on-screen baseball game, or at an actual baseball game. Other selectable options are hit, run, strikeout, home run, etc. One participant becomes an umpire and enters actual baseball field location after a batters hit and other game information. The play results are transmitted through a network provided by Ryan's Play mobile sports application system and method to all other participants as also the winning points for each participant of a successful guess. Incorporated by reference are CD's submitted with disclosure of the Ryan's Play baseball system in Provisional Patent Application U.S. 62/285,327.

The participants in play are rewarded with winning points based upon their prior selection of baseball hit field location and other selectable game options, entered into a smartphone screen of the present invention. The interaction between participants and a live on-screen baseball game or at an actual baseball game provides competition, entertainment, and ranking among participants based on number of points won during a number of plays or at game end.

Further disclosing one aspect of the present invention, the Ryan's Play mobile sports application system and method provides an interactive baseball sports game to a plurality of participants who will make “guesses” as to field options, then further to hits, runs, strikeouts, etc. A player selects ‘in field options’, such as a baseball hit to RF, ‘right field’, CF, ‘center field’, LF, ‘left field’, SS, ‘short stop’, etc. Aside from field options, other options available are Hit/Run/Strikeout, Home run, etc.

Each participant has a smartphone or similar device with screens provided by the Ryan's Play mobile system and method wherein a participant taps a game screen with a preferred field location and other selectable options at a real time on-screen baseball game or at an actual baseball game. The system comprises:

A participant designated an umpire to enter actual baseball field location and other play results;

Participants with hand held smartphone devices;

Ryan's Play on-line screens to enter participants preferred pre-game play guesses of field location of a baseball after a batter's hit and pre-game play selection of hit, run, strikeout, home run, etc.; and

A method of keeping score of the participant's right or wrong entries to accumulate a total of points gained.

In accordance to the above and one more aspect of the present invention, there is provided a system for providing an interactive sports game to a plurality of participants each interactively selecting a preferred field location of a baseball batter's hit and end location of a baseball. Other selectable options are hit, run, strikeout, home run, etc. The system comprises a host controller, the host controller comprising a computer program operable to act as a record keeper on the network comprised of a plurality of participants, and to communicate with the participant's individually to record gains in points of the successful selections from the participants entered in a game screen of the present invention. The system is intended to entertain and is also a game of skill which rewards the most successful participants.

Ryan's Play mobile sports application method is operable to:

(a) solicit and accept from each participant an initial selection of a baseball's trajectory and field location after a baseball batter's hit, and other selectable options such as hit, run, strikeout, home run, etc.;

(b) respond to data input from a game umpire that enters into a host controller the actual field location and hit, run, strike, home run, etc. from a batter's real time hit of a baseball;

(c) accumulate game points from each participant on successful selections; and

(d) rank the participants according to the number of winning game points.

In accordance with another aspect of the present invention, there is provided a method for providing an interactive sports game of baseball to a plurality of participants each wishing to accumulate the most game points, and each operating a participant terminal operable to act as a client on a network, wherein the number of game value units associated with each participant varies in correlation with successful picks of trajectory and baseball field location after a batter's hit. Other selectable options before a play starts is a possible hit, run, strikeout, home run, etc.

According to still another aspect of the present invention, there is provided a method for a game participant, operating a hand held computer, or smartphone, to play an interactive sports game run by an administrator, an umpire of the game, operating a host computer on the network. The host computer normally is a hand held computer or smartphone. The host computer operated by the administrator, an umpire, will be operated in real time to follow the batter's hit and the umpire will enter the field location of the batter's hit, thereby communicating the field location of the batter's hit to the network. Other selectable player options are hit, run, strikeout, home run, etc. Those interacting with their smartphones, having entered their preferred selectable options, will receive points from the network according to successful picks of the various game options.

The present invention further comprises a computer-readable medium storing code for causing a processor controlled system to perform a method for providing an interactive sports game, such as baseball, to a plurality of participants each picking a selection of a batter's hit field location, and selecting hit, run, strike, home run, etc. by operating a participant terminal operable to act as terminal on the network, the system comprising a host controller, the host controller comprising a computer operable to act as a server on the network and to communicate with the participant terminals over the network; and data storage accessible to the host controller, the data storage string information relating to selections of the participants, the method comprising:
(a) The host controller accepting from each participant an initial selection of a batter's hit field location and other game play options, and
(b) An umpire, as designated from one of the participants, to enter an actual batter's hit results from a real time game as shown on a terminal, thereby accessing a data storage and reporting a status of each participant's score, according to points predetermined for each successful selection on a participant's terminal.

The present invention further covers a method comprising:
transmitting, by a server computer, to a participant device configured to execute computer instructions for;
in response to an event related to a sports game and entered by a participant designated an umpire;
triggering a set of data values that represents the event as entered by the umpire, the event comprising a set of data values that represents a successful selection of the event.

### Ryan's Play Baseball Game Flow

In operation a game flows with the following steps provided by screens from Ryan's Play of the present invention:
A player selects “join game” on a terminal down loaded with Ryan's Play screens of the present invention;
A player selects a game from a pre-populated list on the “Public game list screen”;
A player searches for a game by a game creator that has labeled this particular game by a distinctive name such as “Joe's public game”;
Once the game is selected, a pop up screen with “Join game option” is displayed;
The player enters the game if the play is open, as displayed on the Ryan's Play screen, and a countdown has not started yet, if a countdown is started, the player has until the zero count to enter;
If the game has not started, players will go to the public game lobby to wait for the umpire to launch the game, if the game is in progress, the game screen is displayed, or if the countdown has started, a message will be displayed “Ball is in play, please wait”; Participants, named players, will obtain game value points throughout the game plays, as follows:
Players will compete by reaching a certain amount of points before the umpire ends the inning,
Players can invite friends while in a public game by clicking options button on the upper left side of the screen,
Invite friends, click this and a messaging app will appear with a link to a game in the message,
Exit is another option on the screen, and a player can leave and come back to the game at any time, and
A player can play the game until the umpire ends the game, at the end of the game, a player will be brought to a final leaderboard screen that shows total points, and then back to home screen.

One key participant to Ryan's Play is the game umpire, designated from the participants. An umpire will have the following activities to begin the game:
An umpire has a log in screen with an option to create a public game,
An umpire will designate the game name,
An umpire will designate the game location,
An umpire will designate a game start time,
At this point the game will go into a waiting period, called a game lobby, and players can join this game lobby and wait for the umpire to manually launch the game,
The umpire will launch the game after the game lobby and all players will be brought to the first play of the game,
The umpire will track game balls, strikes, runners on base, score, hits, and half inning breaks,
All screen buttons for a live game are independent of one another, the umpire must manually input all information,
When the umpire changes the inning, this will cut off all points for the “Ring” chase,
At every play, the umpire will select result and submit results of a play, next plays will start automatically, and is also a time for players waiting to get into a public game will be admitted to the game,
This process will be repeated until the umpire ends the game by clicking an option button, and
Upon ending the game, the Ryan's Play screen will display the game length (total plays), display the players that played at least one play, and total plays played in the game, and total plays played by the participants.

The following is a player participant flow of events to enter into a game after bringing up Ryan's Play home screen. There are various means of entry into the game as follows:
Click sign up via Facebook™
Click sign up via email
Click “already have an account, sign in”
Click create game
On the game setup screen, enter Game Name
Select game length (5, 10, 20 plays)
Enter if you will umpire the game (yes/no)
Click SMS invites, a message app opens with link and user fills in the destination of message
Click game lobby
Click select umpire (if no umpire selected) tap on name to be umpire
Would you be willing to be a reserve umpire (yes/no)
Click launch game

A participant also has an option to enter a private game as follows:
Click join game on the Ryan's Play home screen
Private games cannot be joined late. If a user clicks on join game and if the game has already started, a message appears “You cannot join a private game once it has already started”,
Once the user closes the above pop up, a game list is displayed and the player should be able to pick a new game to join,
Once a private game has already started, the game name is not clickable on the game list, and is greyed out with a message “game in progress”,
The player can search for another game by entering a Game creator name and clicking a search icon,
The player finds a game on the list and clicks on a game to highlight,
A join game pop up is displayed,
The player is able to select if they are interested in being a reserve umpire (yes/no),
If the player selects yes, then the private game umpire will have the ability to transfer umpire responsibilities to this player if needed, if no is selected then this is not an option,
At this time the player clicks “Join Game” and a game lobby screen is displayed,
The player now selects positions on the field for a play,
The umpire will “close guesses” and a countdown will occur, once a countdown is complete, the game screen will lock, and a “Ball in Play” is displayed, and
A ranking will appear for player rankings (1^{st} place, 2^{nd} place, 3^{rd} place, 4^{th} place, 5^{th} place, etc.).

Turning now to the umpire of the game, the umpire performs the following steps in the private game:
The umpire closes the player's guesses before the pitcher throws the first pitch to a batter,
The umpire and players watch the ball in play on an online real time display,
The umpire then selects “results” and enters the results of the ball in play and hits “Submit”,
The result is processed and the players rankings are displayed on the results screen,
The next play starts with the players guesses open, and the above process repeats until the game is over, and
The final leaderboard screen then displays the 1^{st}, 2^{nd}, and 3^{rd} place players.

A description of the various mobile application screens visible on a participant terminal are discussed further. A first screen displays an introductory Ryan's Play screen for a user/player sign in to a public game of the present invention. There are two types of games for Ryan's Play baseball disclosure, a public game, and a private game. Once the user opens the Ryan's Play app, a landing screen is displayed with options for sign in, either through Facebook™ or via email. With either choice, upon entering all required fields, a user taps ‘create account’ and the Ryan's Play home screen is displayed.

For a sign up with Facebook™, a user taps this option and a Facebook™ authorization screen is displayed. A user signs in using his Facebook™ credentials. Upon a successful login, the user routes back to the Ryan's Play app.

For a sign up via email, a user taps on this option. A sign up form is displayed with details to enter information for email sign up.

A sign up screen where a player enters name, email address, password and promotional code (promo code). A promo code is a promotional code for discounted plays. Upon entering all the required fields, a user taps ‘create account’ and a Ryan's Play home screen is displayed. If the mandatory fields are not entered, an error message is displayed

If a user is already registered, he clicks on sign in and enters his credentials. Upon successful sign in, the Ryan's Play home screen is displayed. If a game umpire is logging in, he only has the option of signing in with username and password. A game umpire controls game play, and enters play results on an umpire screen. These game results apportion game points to the players after each play.

Ryan's Play home screen is used by a participant to create a new game or join an existing game. The mobile application further shows a promotional screen, provided to a user to enter a promo code, if one is available to the user. A promo code assigns a number of plays to a user's account. A promo screen informs a user if a promo code is no longer active. If a promo code is valid, a promo screen is displayed informing the user of how many games his promo code provided to the user's game account.

A create new game screen is now displayed. After a new game is created, a new game details screen is shown to the user. Game details screen identifies game creator, game name, location, date and time, entry fee (in number of plays), a home team, and an away team. Further, a game lobby screen is displayed, showing the players for the new game with the players identified and the number of plays credited to each player's account.

A lobby screen is displayed which shows a ‘cancel game’ on a game lobby screen, as an option for a game umpire to cancel a game. An umpire begins by landing on a home screen and taps ‘create screen’. Once an umpire enters all game details, he taps ‘create game’ and a game lobby screen is displayed. An umpire can launch a game or cancel a game from the game lobby screen. Once the umpire creates a game, a player sees the game name on the list and joins the public game. Once the umpire taps ‘start game’, a public game umpire screen is displayed. A player will see the countdown as shown in countdown screen, before starting a game.

A log in screen details a player login to the public game. A player will only see a ‘Join Game’ option on a home screen, a screen displayed after login. Once a player taps ‘Join Game’, a game list is displayed. A player will choose a game from the game list by either searching or choosing from the game list displayed. Once a game is chosen, the player taps ‘Join Game’. If a chosen game has not started, a player game lobby screen is displayed. If the game has already started and the player's guesses have been closed, then a pop up message will be displayed to the player ‘the ball is in play, please wait for the next play’. If player's guesses are open, then a message pop up says ‘your game begins in 3..2..1 with a countdown’. An in game screen, is then displayed.

The mobile application further shows a countdown screen with a count down for a game to begin in 3 . . . 2 . . . 1 counts as displayed on the countdown screen.

The mobile application further shows a game screen identifying game players and their gained points from previous plays.

A game screen further denotes open play. Players are able to choose or “guess” the play options on the field. A batters hit will be to left field, center field, or right field, as guesses, etc. Also shown on the game screen are the players in the game and their respective points. Further displayed is a game screen with 5 seconds remaining for the players to make their play selections. The game screen further shows a countdown from 5 seconds to zero seconds, then the ball in play screen is displayed.

A results screen is displayed showing results of the last play, as entered by the game umpire, and showing the points earned, for the successful players, those who guessed the ball would be hit to right field. After the results screen is displayed, then a new game is initiated with a new display of game screen. If a player taps on the toggle for stats on the game screen, then a game statistics screen is displayed.

A game screen further displays a screen keyboard brought on line by tapping on a ‘Chat’ option on the left panel of the game screen. A player can then send messages to other players, or chat on line while the game is open. A player can start conversations by tapping on the text box and typing messages on the text box. Another option is tapping on ‘Leaderboard’ on the left panel of the game screen, which displays a screen with player rankings.

A game screen further displays game results by tapping ‘Play by Play’ on the left panel of the game screen. A play by play results is then shown on the left panel of the game screen, showing results of each play, hit to left field, etc.

An ‘Add More Plays’ screen is displayed when a player taps on the plus icon on the game screen. As shown on this screen, there are options on the ‘Add More Plays’ screen, options of additional plays, with their associated cost to purchase. Once the player chooses an option, a payment/purchase screen is displayed to purchase the plays. At this point, when a player selects an option of plays to purchase, a pop up text is displayed with text “would you like to purchase” Yes/No. If yes, then a message is displayed that the plays are added to the players account.

A left panel of the game screen displays an ‘Invite Friends’ option. A player can tap on the 3 dots shown and select ‘Invite Friends’. When this is done, a confirmation message is displayed. Once it's a ‘Yes’ on the confirmation screen, an Invite Friends screen is displayed.

Also, when an ‘Exit Game’ option is chosen, a confirmation pop up is displayed with a message “are you sure you want to exit this game? Yes/No’. If ‘Yes’ is chosen, the player exits the game and a home screen is displayed. A player can always come back to the public game while it is still active. If ‘No’ is chosen, the game screen remains on line.

A Game Over screen is displayed, indicating to the player what position the player came, 1^{st}, 2^{nd}, etc. regarding the last game. Also shown are points earned. A player can navigate to the final leader board from the Game Over screen.

A final Leader Board screen, shows a player's standing and points earned. A player can tap the back arrow to navigate to the home screen.

An umpire for a Ryan's Play game has a public game umpire screen. Turning to a left panel of the umpire screen, there is an ‘A’ team and an ‘H’ team designated, with ‘R/H/E’ entries for Runs, Hits, and Errors. The ‘A’ team is the Away team, the ‘H’ team is the home team. At the ‘R/H/E’ fields, there is a ‘+’ plus sign, and a minus sign. Whenever the umpire wants to add numbers, he hits the plus/minus symbol. Everything on the left has nothing to do with the right panel of the umpire screen, it is not dependent on the scores/points. Further shown on the left panel are fields for ‘Inning’, ‘Runners’, and ‘Batter. The ‘Inning’ field starts from the 1, or first inning, ‘Runners’ are indicated on the three base symbols, and ‘Batter’ is indicated as a right or left handed batter. A ‘½ Inning Break’ field is used by the umpire to pause the game. When this field is tapped, a pop up is displayed with text “Game is Paused”. The umpire has to manually tap on the button to pause or resume the break.

Play should be open after every break. An Umpire can open/close guesses during a game. After the play is submitted, the guesses should be open again.

At the bottom of the left panel is a pitch count field. For a pitch count, the umpire has to tap on the bubbles shown on the left panel separately. Once the umpire taps these bubbles, it goes up by one bubble per tap, and once all bubbles are filled, the screen goes back to none (grey) again. For example, B has 3 bubbles, after all 3 are full, a 4^{th} tap will make all grey and the 5^{th} tap will fill one circle.

A Play by Play screen is used by the game umpire to edit the play by play results. Shown on left panel are game results for each play. The game umpire will be able to edit the play by play results by tapping on the ‘wrench’ tool symbol to the right of the play results.

The above is a disclosure of Ryan's Play game creation and game flow for a public game. Another version of the present invention is a creation of a private game. A private game is a close game between a small group of participants, normally invited by an ‘Invite Friends’ function through the game lobby screen. A participant opens a ‘Create Private Game’ screen and creates a private game by entering a game name, normally less than 32 characters to define the private game, for example a game name “RyanW749”. At this point the participant creating the private game becomes the default umpire. Once the game is created successfully, the ‘Game Lobby’ screen is displayed.

From the ‘Game Lobby’ screen, the game creator will be able to invite friends to join the game by accessing their messaging app. Once the game creator taps ‘Invite Friends’, the messaging app will open with a preloaded text such as “Download RP Baseball with this link ryansplay.com/app.dlex.” Search for game creator “RyanW749”. As other players join the private game they will show up in the game lobby. After the game creator taps ‘Launch Game’, a countdown screen begins, same as in the public game disclosure.

Other options are available, such as a change in a game umpire. The creator of the game can tap ‘Switch Umpire’ on the game lobby screen. Participants that opted to be reserve umpires will be listed. At this point the game creator will choose a player that will be the umpire and confirm. The player that is chosen to be the game umpire will get a confirmation message that he is the game umpire for the created game.

A ‘Switch Umpire’ screen displays a list of players that opted to be reserve umpires is shown. A confirmation screen is further displayed to confirm a new umpire.

A game screen displayed in a participant's terminal allows entry of a player's “guesses” as to field options such as field options, then further to hits, runs, strikes, etc. A player selects ‘in field options’ first, such as a baseball hit to RF, ‘right field’, CF, ‘center field’, LF, ‘left field’, SS, ‘short stop’, etc. After a field option is selected, then other options available are Hit/Run/Strike, etc.

This completes the disclosure of Ryan's Play mobile sports application system and method for the game of Baseball. We continue further to the game of Football, and the possible guesses to enter into Football screens of the present invention.

### Football

American football (referred to as football in the United States and Canada, also known as gridiron elsewhere) is a sport played by two teams of eleven players on a rectangular field with goalposts at each end. The offense, the team with control of the oval-shaped football, attempts to advance down the field by running with or passing the ball, while the team without control of the ball, the defense, aims to stop their advance and take control of the ball for themselves. The offense must advance at least ten yards in four downs, or plays, or else they turn over the football to the opposing team; if they succeed, they are given a new set of four downs. Points are primarily scored by advancing the ball into the opposing team's end zone for a touchdown or kicking the ball through the opponent's goalpost for a field goal. The team with the most points at the end of a game wins.

In accordance to the above and one more aspect of the present invention, there is provided a system for providing an interactive sports game to a plurality of participants each interactively selecting various options in a football game. The system comprises a host controller, the host controller comprising a computer program operable to act as a record keeper on the network comprised of a plurality of participants, and to communicate with the participant's individually to record gains in points of the successful selections from the participants entered in a game screen of the present invention. The system is intended to entertain and is also a game of skill which rewards the most successful participants.

The host controller is operable:
(a) to solicit and accept from each participant an initial selection of game options in a football game, selectable options such as:
   Guessing if there will be a first down on a drive
   Have an Over/Under first down guess for a drive (example: Over/Under 3 first downs on a drive)
   Will there be points scored on a particular drive. Field Goal kicked? Touchdown? Safety?
   Will there be a turnover on a particular drive
   Picking who wins the game
   Guessing if the next play will he a run or pass
   Guessing if there will be a sack on a particular drive
   Guessing over/under how many points a team will score or both teams combined will score
   Will there be a safety in the game
   Guessing in what direction a play will go (i.e. Run Left, Pass Right, etc.)
   Longest touchdown play scored in the game by either team (i.e. longest scoring play will be over/under 45 yards)
   Over/Under how many points scored in the first half
   Pick who will be winning the game at half time
   Pick who will win the second half of the game
   How many total first downs will be achieved in the game (over/under)
   How many first downs will be achieved in the second half (over/under)
   Guessing how many sacks will be achieved by both teams in a game (over/under)
   Which team has more total yards in the game
   How many touchdown passes will each team's QB have (over/under)
   How many rushing touchdowns will each team have (over/under)
   How many total yards achieved by each team's offense in the game
   How many total passing yards will each team achieve
   How many rushing yards will each team achieve
   Which team has more rushing yards at half time
   Which team has more rushing yards in second half
   Which team has more passing yards at half time
   Which team has more passing yards in second half
(b) respond to data input from a game umpire that enters into the host controller the after-action selectable options, options as noted above, with actual information from a football game;
(c) Accumulate game points from each participant on successful selections of the selectable game options; and
(d) Summarize the total number of game points for each participant to determine the most successful participants and their ranking.

Looking at a popular world-wide sport, we discuss the game of Cricket.

### Cricket

Turning now to another sport as an application of the game concepts of Ryan's Play mobile sports application system and method, we look at the game of Cricket. Cricket is a bat-and-ball game played between two teams of 11 players each on a field at the center of which is a rectangular 22 yard long pitch. The game is played by approximately 120 million players in many countries, making it the world's second most popular sport. Each team takes its turn to bat, attempting to score runs, while the other team fields. Each turn is known as an inning.

The bowler delivers the ball to the batsman who attempt to hit the ball with his bat away from the fielders so he can run to the other end of the pitch and score a run. Each batsman continues batting until he is out. The batting team continues batting until ten batsmen are out, or a specified number of overs of six balls have been bowled, at which time the teams switch roles and the fielding team comes in to bat.

The cricket field is usually oval in shape, with a rectangular pitch at the center. The edge of the playing field is marked with a boundary, which could be a fence, part of the stands, a rope or a painted line.

At each end of the pitch is a wooden target called a wicket, placed 22 yards apart. The pitch is marked with painted lines: a bowling crease in line with the wicket, and a batting or popping crease four feet in front of it. The wicket is made of three vertical stumps supporting two small horizontal bails. A wicket is put down if at least one bail is dislodged, or one stump is knocked down (usually by the ball, but also if the batsman does it with his body, clothing, or equipment). This is also described as breaking, knocking down, or hitting the wicket—though if the ball hits the wicket but does not dislodge a bail or stump then it is not down.

At any instant each batsman owns a particular wicket (usually the one closer to him) and, except when actually batting, is safe when he is in his ground. This means that at least one part of his body or bat is touching the ground behind the popping crease. I his wicket is put down while the ball is live and he is out of his ground then he is dismissed.

The two batsmen take positions at opposite ends of the pitch. One designated member of the fielding team called the bowler, bowls the ball from one end of the pitch to the striking batsman at the other end. The batsman at the bowling end is called the non-striker, and stands to the side of his wicket, behind his crease. Another member of the fielding team, the wicket keeper, is positioned behind the striker's wicket.

The fielding team's other nine members stand outside the pitch, spread out across the field. The fielding captain often strategically changes their position between balls. There is always an umpire at each end of the pitch.

In accordance to the above and one more aspect of the present invention, Ryan's Play mobile sports application system and method, there is provided a system for providing an interactive sports game to a plurality of participants each interactively selecting various options in a Cricket game.

Accordingly, the game of Cricket can have multiple selectable options in an application of Ryan's Play during a game period such as the following selectable options during an inning:
Bowler's no ball, how many in an inning
Bowler's wide ball, how many in an inning
Bowler's Yorker ball, how many in an inning
Bowler's full toss, how many in an inning
Bowler's put down of wicket, how many in an inning
Batsman out by leg before wicket, ‘LBW’, how many in an inning
Batsman caught out ball, how many in an inning
Batsman caught and bowled, how many in an inning
Batsman caught behind, how many in an inning
How many Team runs during an inning
him many run outs for each team during an inning
How many balls over the field boundary during an inning
How many balls over the field boundary worth six runs
How many balls over the field boundary worth four runs
Batsman byes during an inning
Batsman leg byes during an inning
Batsman stumped, how many during an inning
How many no balls during an inning
How many wide balls during an inning
How many century runs during an inning
How many “Howzat” challenges during an inning
Will the match end with a draw?
Which team has more runs, thereby winning the match

### Basketball

Another popular sport for application of the present invention, the game concepts of Ryan's Play mobile sports application system and method, is the game of Basketball. Basketball is a sport played by two teams of five players on a rectangular court. The objective is to shoot a ball through a hoop 18 inches in diameter and 10 feet high mounted to a backboard at each end. Basketball is one of the world's most popular and widely viewed sports. The National Basketball Association (NBA) is the most popular and widely considered to be the highest level of professional basketball in the world and NBA players are the world's best paid sportsmen, by average annual salary per player.

A team can score a field goal by shooting the ball through the basket during regular play. A field goal scores three points for the shooting team if the player shoots from behind the three-point line, and two points if shot in front of the line. A team can also score via free throws, which are worth one point, after the other team was assessed with certain fouls. The team with the most points at the end of the game wins, but additional time (overtime) is issued when the score is tied at the end of regulation. The ball can be advanced on the court by bouncing it while walking or running or throwing it to a teammate. It is a violation to lift or drag one's pivot foot without dribbling the ball, to carry it, or hold the ball with both hands then resume dribbling.

Accordingly, the game of Basketball can have multiple selectable options in an application of Ryan's Play mobile sports application system and method during a game quarter such as:
Number of points for each team during a game quarter
Number of two point shots per team during a game quarter
Number of three point shots per team during a game quarter
Number of free throws per team during a game quarter
Number of two point shots per team at half-time, and at game end
Number of three point shots per team at half-time, and at game end
Number of free throws per team at half-time, and at game end
Number of points for each team at half-time
Number of points for a particular player during a game quarter
Number of points for a particular player at half-time
Number of points at game end for a particular player
Number of fouls for a particular player during a game quarter
Number of fouls for a particular player at half-time
Number of fouls for a particular player at game end

### Ice Hockey

Turning now to another sport that can have an application of the present invention, we look at Ice Hockey. Ice hockey is a contact team sport played on ice, usually in a rink, in which two teams of skaters use their sticks to shoot a vulcanized rubber puck into their opponent's net to score points. Ice hockey teams usually consist of four lines of three forwards, three pairs of defensemen, and two goaltenders. Normally, each team has five players who skate up and down the ice trying to take the puck and score a goal against the opposing team. Teams normally have a goaltender as their sixth on-ice player, whose job is to prevent the puck from entering the goal.

In North America, the National Hockey League (NHL) is the highest level for men's hockey and the most popular. The Kontinental Hockey League (KHL) is the highest league in Russia and much of Eastern Europe. Ice hockey is the official national winter sport of Canada. The International Ice Hockey Federation (IIHF) is the formal governing body for international ice hockey.

The objective of the game is to score goals by shooting a hard vulcanized rubber disc, the puck, into the opponent's goal net, which is placed at the opposite end of the rink. The players use their sticks to pass or shoot the puck.

In accordance to the above and one more aspect of the present invention, Ryan's Play, there is provided a system for providing an interactive sports game to a plurality of participants each interactively selecting various options in an Ice hockey game.

Accordingly, the game of Ice Hokey can have multiple selectable options in an application of Ryan's Play during a game period such as:
Number of goals for each team during a game period, and at game end
Number of penalties per team during a game period, and at game end
Number of minor penalties per team during a game period, and at game end
Number of major penalties per team during a game period, and at game end
Number of double minor penalties per team during a game period, and at game end
Will there be a sudden death overtime at end of regulation?
Will there be a shootout at end of sudden death overtime?
Number of game misconducts per team at each period and at game end
Will there be a goal scored in the first ten (10) minutes of the first period
Will there be a goal scored in the first ten (10) minutes of the second period
Will there be a goal scored in the first ten (10) minutes of the third period

### Soccer

Taking a look at another sport adaptable to the application of Ryan's Play mobile sports application and method, we also present the game of Soccer.

Association football, more commonly known as football or soccer, is a sport played between two teams of eleven players with a spherical ball. It is played between two teams of eleven players with a spherical ball. It is played by 250 million players in over 200 countries, making it the world's most popular sport. The game is played on a rectangular field with a goal at each end. The object of the game is to score by getting the ball into the opposing goal.

The goalkeepers are the only players allowed to touch the ball with their hands or arms while it is in play and only in their penalty area. Outfield players mostly use their feet to strike or pass the ball, but may also use their head or torso to so instead. The team that scores the most goals by the end of the match wins. If the score is level at the end of the game, either a draw is declared or the game goes into extra time and/or a penalty shootout depending on the format of the competition. Association football is governed internationally by the International Federation of Association Football (FIFA) which organizes World Cups for both men and women every four years.

In game play, players attempt to create goal-scoring opportunities through individual control of the ball, such as by dribbling, passing the ball to a team-mate, and by taking shots at the goal, which is guarded by the opposing goalkeeper. Opposing players may try to regain control of the ball by intercepting a pass or through tackling the opponent in possession of the ball; however, physical contact between opponents is restricted. Association football is generally a free-flowing game, with play stopping only when the ball has left the field of play or when play is stopped by the referee for an infringement of the rules. After a stoppage, play recommences with a specified restart.

A standard association football match consists of two periods of 45 minutes each, known as halves. Each half runs continuously, meaning that the clock is not stopped when the ball is out of play. There is usually a 15 minute half time break between halves. The end of the match is known as full time. The referee is the official timekeeper for the match, and may make allowance for time lost through substitutions, injured players requiring attention, or other stoppages. This added time is called additional time in FIFA rules. A game tied at the end of regulation may go into extra time, which consists of two further 15 minute periods. If the score is still tied after extra time, a penalty shootout can result. Penalty shootout goals do not count towards the final score.

When the ball becomes out of play, there are eight restart methods to continue the match:
Kick off, following a goal by the opposing team
Throw in, when the ball has crossed the touchline
Goal kick, when the ball has wholly crossed the goal line touched by a player of the attacking team
Corner kick, when the ball has wholly crossed the goal line touched by a player of the defending team
Indirect free kick, awarded to the opposing team following “non-penal” fouls
Direct free kick, awarded to fouled team following certain listed “penal-fouls”
Penalty kick, awarded to the fouled team
Dropped ball, occurs when the referee has stopped play for any other reason

In accordance to the above and one more aspect of the present invention, Ryan's Play mobile sports application system and method, there is provided a system for providing an interactive sports game to a plurality of participants each interactively selecting various options in a Soccer game.

Accordingly, the game of Soccer can have multiple selectable options in an application of Ryan's Play mobile sports application system and method during a game period such as:
Number of goals for each team during a game halve, and at game end
Number of penal fouls per team during a game halve, and at game end
Number of non-penal fouls per team during a game halve, and at game end
Number of Kick offs per team during a game halve, and at game end
Number of Throw ins per team during a game halve and at game end
Number of Goal kicks per team during a game halve and at game end
Number of Corner kicks per team during a game halve and at game end
Number of Indirect free kicks per team during a game halve and at game end
Number of Direct free kicks per team during a game halve and at game end
Will the home team score a goal in the first 22½ minutes of the first halve
Will the visiting team score a goal in the first 22½ minutes of the first halve
Will the home team score a goal in the first 22½ minutes of the second halve
Will the visiting team score a goal in the first 22½ minutes of the second halve
Number of non-penal fouls for a particular player at each halve and at game end

### Golf

Turning now to a popular sport, the game of Golf, with an application of Ryan's Play mobile sports application system and method. Golf is a club and ball sport in which players use various clubs to hit balls into a series of holes on a course in as few strokes as possible.

Golf is one of the few ball games that do not require a standard playing area. The game is played on a course with an arranged progression of either nine or 18 holes. Each hole on the course must contain a tee box to start from, and a putting green containing the actual hole. There are other standard forms of terrain in between, such as the fairway, rough, and hazards, but each hole on a course is unique in its specific layout and arrangement.

Golf is played for the lowest number of strokes by an individual, known as stroke play, or the lowest score on the most individual holes in a complete round by an individual or team, known as match play.

On the golf course, the levels of grass are varied to increase difficulty, or to allow for putting in the case of the green. While many holes are designed with a direct line of sight from the teeing area to the green, some holes may bend either to the left or to the right. This is commonly called a “dogleg”, a hole is called a “dogleg left” if the hole angles to the left and a “dogleg right” if it bends to the right. If a hole has both, then it is called a “double dogleg”.

Every round of golf is based on playing a number of holes in a given order, either 9 holes or 18 holes. Playing a hole on a golf course is initiated by putting a ball into play by striking it with a club on the teeing ground. For this first shot on each hole, it is allowed to use a tee to elevate the golf ball above ground, for better distance.

The initial shot is commonly called a “drive” and is commonly made with a wood club called a “driver”. Once the ball comes to rest, the golfer strikes it again as many times as necessary using shots that are variously known as a “lay up”, an “approach”, a “pitch”, or a “chip”, until the ball reaches the green, where the golfer “putts” the ball into the hole. The goal of getting the ball into the hole in as few strokes as possible may be impeded by obstacles such as areas of longer grass called “rough” (usually found alongside fairways) which both slows the ball and makes it harder to advance. Other obstacles are “doglegs” which often require shorter shots to play around them, or bunkers (sand traps) and water hazards such as ponds or streams.

In stroke play competitions each player plays his or her ball until it is holed no matter how any strokes that may take. In match play it is acceptable to pick up one's ball and “surrender the hole” after enough strokes have been made by a player that it is mathematically impossible for the player to win the hole.

Penalties are incurred in certain situations. They are counted towards a player's score as if there were extra swing(s) at the ball. Strokes are added for rule infractions or for hitting one's ball into an unplayable situation.

A lost ball or a ball hit out of bounds result in a penalty of one stroke and distance. A one stroke penalty is assessed if a player's equipment causes the ball to move or the removal of a loose impediment causes the ball to move. If a golfer makes a stroke at the wrong ball or hits a fellow golfer's ball with a putt, the player incurs a two stroke penalty. Most rule infractions lead to stroke penalties but also can lead to disqualification.

A golfer chooses a golf club, grip, and stroke appropriate to the distance:
The drive or full swing is used on the teeing ground and fairway, typically with a wood or long iron, to produce maximum distance.
The approach or ¾ swing is used in medium and long distance situations where good accuracy is desired.
The chip or half swing is used for relatively short distance shots near the green.
The putt is used in short distance shots on or near the green.

A drive shot has several possibilities such as a “hook”, “pull”, “draw”, “fade”, “push”, or “slice”. These possible shots will require more strokes for a player to hole out.

In the matter of scoring and handicapping, a par (score) is the number of strokes a skilled golfer should require to complete play of the hole. The minimum par of any hole is 3 because par always includes a stroke for the tee shot and two putts. Pars of 4 and 5 strokes are common; more rarely a few courses feature par 6 and par 7 holes. Strokes other than the tee shot and putts are expected to be made from the fairway. Placing the ball on the green with two strokes remaining for putts is called making “green in regulation” or GIR.

Eighteen hole courses typically total an overall par score of 72 for a complete round. Other pars exist from 68 up to 76.

The goal is to play as few strokes per round as possible. A golfer's score is usually expressed as the difference between the player's number of strokes and the par score. A hole can produce various strokes above and below par, including a hole in one. The specific terms are the following:

| | |
|---|---|
| Condor | four strokes under par |
| Albatross (Double Eagle) | three strokes under par |
| Eagle | two strokes under par |
| Birdie | one stroke under par |
| Par | equal to par |
| Bogey | one stroke over par |
| Double Bogey | two strokes over par |
| Triple Bogey | three strokes over par |

There are two forms of golf play, match play and stroke play. In match play, two players or two teams play each hole as a separate contest against each other. The party with the lower score wins that hole, or if the scores of both players or teams are equal the hole is “halved” or tied. The game is won by the party that wins more holes than the other.

In stroke play, the score achieved for each and every hole of the round or tournament is added to produce the total score, and the player with the lowest score wins in stroke play. If there is a tie after the regulation number of holes, a playoff takes place between the players. Playoffs are either sudden death or employ a pre-determined number of holes, anywhere between three to a full 18. In sudden death the player with the lowest score wins.

Team play variations are Foursome and Fourball. In a Foursome match, this is played between two teams of two players each, in which each team has only one ball and players alternate playing it. Foursomes can be played as match play or stroke play.

In Fourball, this is also played between two teams of two players each, but every player plays their own ball and for each team, the lower score on each hole counts. Fourballs can be played as match play or stroke play.

In accordance to the above and one more aspect of the present invention, Ryan's Play, there is provided a system for providing an interactive sports game to a plurality of participants each interactively selecting various options in a Golf game.

Accordingly, the game of Golf can have multiple selectable options in an application of Ryan's Play during a game period such as:
A drive shot from a player will be a hook
A drive shot from a player will be a draw
A drive shot from a player will be a fade
A drive shot from a player will be a push
A drive shot from a player will be a slice
A player's score after a playing a hole will be a Condor, four strokes under par
A player's score after a playing a hole will be an Albatross (Double Eagle), three strokes under par
A player's score after playing a hole will be an Eagle, two strokes under par
A player's score after playing a hole will be a Birdie, one stroke under par
A player's score after playing a hole will be at Par, equal to par
A player's score after playing a hole will be a Bogey one stroke over par
A player's score after playing a hole will be a Double Bogey, two strokes over par
A player's score after playing a hole will be a Triple Bogey, three strokes over par
A player's score after playing a hole will be a hole in one
Will a player hit the ball on the fairway
Will a player hit the ball on the rough
Will a player make the green in regulation (GIR)

### Tennis

Turning now to a popular sport, the game of Tennis, with an application of Ryan's Play mobile sports application system and method. Tennis is a racquet sport that can be played individually against a single opponent (singles) or between two teams of two players each (doubles). Each player uses a racquet that is strung with cord to strike a hollow rubber ball covered with felt over or around a net and into the opponent's court. The object of the game is to play the ball in such a way that the opponent is not able to play a good return. The opponent who is unable to return the ball will not gain a point, while the opposite opponent will.

Tennis is an Olympic sport and is played at all levels of society and at all ages. The sport can be played by anyone who can hold a racquet, including wheelchair users.

Tennis is an international sport. The four Grand Slam tournaments are popular: the Australian Open played on hard courts, the French Open played on red clay courts, Wimbledon played on grass courts, and the US Open played also on hard courts. The highest governing body for the game of Tennis is the International Tennis Federation.

Tennis is played on a rectangular, flat surface, usually grass, clay, or a hardcourt of concrete, asphalt, or acrylic; occasionally carpet is used for indoor play. The court is 78 feet long, and 27 feet wide for singles matches and 36 feet wide for doubles matches. The center net is 3 feet 6 inches high at the posts and 3 feet high at center.

The lines that delineate the width of the court are called the baseline and the service line (middle of the court). The short mark in the center of each baseline is referred to as either the hash mark or the center mark. The outermost lines that make up the length are called the doubles sidelines. The lines to the inside of the doubles sidelines are the singles sidelines. The line that runs across the center of a player's side of the court is called the service line because the serve must be delivered into the area between the service line and the net on the receiving side.

The players (or teams) start on opposite sides of the net. One player is designated the server, and the opposing player is the receiver. In a legal service, the ball travels over the net (without touching it) and into the diagonally opposite service box. If the ball hits the net but lands in the service box, this is a let or net service, which is void and the server retakes that serve. The player can serve any number of let services in a point and they are always treated as voids and not as faults. A fault is a serve that falls long or wide of the service box, or does not clear the net. There is also a foot fault, which occurs when a player's foot touches the baseline or an extension of the center mark before the ball is hit. If the second service is also a fault, the server double faults, and the receiver wins the point. However, if the serve is in, it is considered a legal service.

A legal service starts a rally, in which the players alternate hitting the ball across the net. A legal return consists of the player or team hitting the ball before it has bounced twice or hit any fixtures except the net, provided that it still falls in the server's court. A player or team cannot hit the ball twice in a row. The ball must travel past the net into the other player's court. A player or team cannot hit the ball twice in a row. The ball must travel past the net into the other player's court. A ball that hits the net during a rally is still considered a legal return. The first player or team to fail to make a legal return loses the point. The server then moves to the other side of the service line at the start of a new point.

A game consists of a sequence of points played with the same player serving. A game is won by the first player to have won at least four points in total and at least two points more than the opponent. The running score of each game is described in a manner peculiar to tennis: scores from zero to three points are described as “love”, “fifteen”, “thirty”, and “forty” respectively. If at least three points have been scored by each player, making the player's scores equal at forty apiece, the score is not called out as “forty-forty”, but rather as “deuce”. If at least three points have been scored by each side and a player has one more point than his opponent, the score of the game is “advantage” for the player in the lead.

The score of a tennis game during play is always read with the serving player's score first. In tournament play, the chair umpire calls the point count (e.g. “fifteen-love”) after each point. At the end of a game, the chair umpire also announces the winner of the game and the overall score.

A set consists of a sequence of games played with service alternating between games, ending when the count of games won meets certain criteria. Typically, a player wins a set by winning at least six games and at least two games more than the opponent. If one player has won six games and the opponent five, an additional game is played. If the leading player wins that game, the player wins the set 7-5. If the trailing player wins one more game and thus the set, to give a final set score of 7-6. A “love” set means that the loser of the set won zero games, colloquially termed a ‘jam donut’ in the USA. In tournament play, the chair umpire announces the winner of the set and the overall score. The final score in sets is always read with the winning player's score first, e.g. “6-2, 4-6, 6-0, 7-5”.

A match consists of a sequence of sets. The outcome is determined through a best of three or five sets system. On the professional circuit, men play best of five set matches' at all four Grand Slam tournaments.

A game point occurs in tennis whenever the player who is in the lead in the game needs only one more point to win the game. The terminology is extended to sets (set point), matches (match point), and even championships (championship point).

A break point occurs if the receiver, not the server, has a chance to win the game with the next point.

A player has eight basic shots in a game: the serve, forehand, backhand, volley, half-volley, overhead smash, drop shot, and lob. A winning serve that is not touched by the opponent is called an “ace”. A serve that hits the net and bounces over into the correct diagonal box is called a “let”, and the server gets two more additional serves to get in.

A volley is a shot returned to the opponent in mid-air before the ball bounces, generally performed near the net. A half volley is made by hitting the ball on the rise just after it has bounced. A swinging volley is hit out of the air as the player approaches the net. It is an offensive shot used to take preparation time away from the opponent, as it returns the ball into the opponent's court much faster than a standard volley.

In accordance to the above and one more aspect of the present invention, Ryan's Play, there is provided a system for providing an interactive sports game to a plurality of participants each interactively selecting various options in a game of Tennis.

Accordingly, the game of Tennis can have multiple selectable options in an application of Ryan's Play during a game period such as:
Will a serving player's serve be a “let”?
Will a serving player's serve be a “fault”?
Will a serving player's second serve be a “fault”?
Will a receiving player's return be a “volley”?
Will a player's score be “love”?
Will a player's score be “fifteen”?
Will a player's score be “thirty”?
Will a player's score be “forty”?
Will the player's score be a “deuce”?
Will a player's match be best of five sets, thereby winning the match?
Will a player have a game point?
Will a player have a set point?
Will a player have a match point?
Will a receiving player have a break point?
Will a receiving player have a double break point?
Will a receiving player have a triple break point?
Will a receiving player convert a break point?
Will a receiving player fail to convert a break point?
Will a receiving player's return be a “half volley”?
Will a receiving player's return be a “swinging volley”?

The present invention Ryan's Play has been described in terms of specific embodiments incorporating details to facilitate the understanding of principles of construction and operation of the invention. Such reference herein to specific embodiments and details thereof is not intended to limit the scope of the claims appended thereto. It will be readily apparent to one skilled in the art that other various modifications may be made in the embodiment of the chosen for illustration without departing from the spirit and scope of the invention as defined by the claims.

What is claimed is:

1. A mobile sports application method for providing an interactive sports game to a plurality of participants, a method comprising a game screen on a participant's terminal for participant selection of a game play option, a game administrator, a host controller, and a network.

2. A mobile sports application method of claim 1 wherein a game screen has selectable game play options selectable by tapping a spot on the game screen or clicking on a selection of possible outcomes of a game play option.

3. A mobile sports application method of claim 1 wherein a host controller is a computer server with storage equipped with a mobile application of the present invention.

4. A mobile sports application method of claim 1 wherein a network is comprised of a host controller and participant terminals communicating via the world wide web, internet, or dedicated communications medium.

5. A mobile sports application method of claim 1 wherein a game administrator is an umpire selected from among the group of participants, the umpire accessing an umpire screen of the mobile application, and administrating the game by communicating actual game option outcomes to a host controller.

6. A mobile sports application method of claim 1 wherein a host controller accepts an entry from a game umpire and responds to an input from the game umpire of actual game play option outcome, accessing its host controller storage and reports a status of participant acquired points on a participant terminal, the status including information as to performance of the participants by ranking according to acquired game points, the number of game points associated with each participant's successful selections.

7. A method for providing an interactive sports game to a plurality of participants, a method comprising a host controller with storage, an application stored in the host controller storage, an administrator, a network, and participant terminals to communicate with a host controller.

8. A method of claim 7 wherein the host controller is a computer server with storage.

9. A method of claim 7 wherein an application stored in the host controller provides for queries applicable to a sports event, whether a televised or actual sports event, wherein the application accepts participant's selection of the outcome of a game play option of the sports event.

10. A method of claim 7 wherein an administrator is one of the game participants who records the actual outcome of a game play option of a sports event, communicating to the host controller the actual outcome of a game play action of the sports event.

11. A method of claim 7 wherein a network is comprised of a host controller, participant terminals, the world wide web, internet, or dedicated medium to communicate with a host controller and participant terminals.

12. A method of claim 7 wherein participant terminals are smartphones, tablets, personal digital assistants, or computer terminals equipped with a mobile application of the present invention.

13. A method for administering an interactive sports event comprising an event administrator, a host controller, group of participants, a network, and participant terminals; a method administering an interactive sports event with the following steps:
i. Providing a computer-readable medium storing code for causing a processor controlled system to provide an interactive sports game to a plurality of participants;
ii. Providing a plurality of participants with participant terminals such as hand held smartphones, tablets, personal digital assistants, or computer terminals equipped with a mobile application;
iii. Providing a mobile application to a processor controlled system and participant terminals for providing an interactive sports game to a plurality of participants;
iv. Interfacing a host controller to a plurality of participants using participant terminals such as smartphones or similar devices unto a network communicating with a host controller;
v. Accepting participant selections of a sport event action during a televised or actual sport event, these participant game action selections accepted by a host controller;
vi. Designating a participant as an administrator, named an umpire, to enter actual results from a sport game action in a sporting event in an umpire terminal communicating with a host controller;
vii. Displaying on participant terminals the actual sport event results and awarding points to successful participant selections, saving these sport event results in storage and displaying participant rankings in competition with other participants.

14. A method of administrating an interactive sports event as in claim 13 wherein a host controller is a computer server with a memory and an application stored in its memory.

15. A method of administrating an interactive sports event as in claim 13 wherein an event administrator is one of the participants communicating with a host controller through a network, communicating to the host controller game event results in an interactive sports event.

16. A method of administrating an interactive sports event as in claim 13 wherein a network is the world wide web or a dedicated communications medium to accept communication from participant terminals, or an umpire terminal, relaying these communications to a host controller.

17. A method of administrating an interactive sports event as in claim 13 wherein participant terminals are smartphones, personal digital assistants PDA's, tablets, or computer devices with an application of the present invention stored in memory.

18. A method of administrating an interactive sports event as in claim 13 wherein a sports event administrator, named an umpire, is selectable from a plurality of participants, any participant can assume the function of administering a sports event with an umpire terminal equipped with umpire computer code to communicate game event results to a host controller.

19. A method of administrating an interactive sports event as in claim 13 wherein a host controller tallies game event results received from an umpire and awards points to participants according to successful game event selections and stores participant points in memory.

20. A method of administrating an interactive sports event as in claim 13 wherein a host controller relays and displays participant points on a participant terminal, and ranks participants according to number of points accumulated.
